(19) United States
(12) Patent Application Publication
(10) Pub. No.: US 2005/0263366 A1
(43) Pub. Date: Dec. 1, 2005

(54) Mechanically applied coupling assembly

(75) Inventor: Gregory M. Eisengruber, Saginaw, MI (US)

Correspondence Address: BROOKS KUSHMAN P.C., 1000 TOWN CENTER, TWENTY-SECOND FLOOR, SOUTHFIELD, MI, 48075, US

(73) Assignee: Means Industries, Inc., Saginaw, MI (US)

(21) Appl. No.: 10/853,881

(22) Filed: May 26, 2004

(51) Int. Cl. F16D 13/54

(52) U.S. Cl. 192/70.3; 192/99 A

(57) ABSTRACT

A mechanically applied coupling assembly (10) includes an annular housing (12) and an inner member (14) that are selectively rotatively coupled by a coupling pack (16) through operation of a set of actuating levers (26). The actuating levers have interlocking formations provided by a projection (36) and an opening (38) on opposite sides of each actuating lever so as to retain the actuating levers to each other and maintain positioning of the actuating levers with respect to the housing.

### BACKGROUND OF THE INVENTION

1. Field of the Invention

This invention relates to a mechanically applied coupling assembly which can be utilized as a clutch or brake, etc.

2. Background Art

Mechanically applied coupling assemblies that can be used as a clutch or brake are disclosed by U.S. Pat. No. 4,630,720 Boni and U.S. Pat. No. 6,332,514 Chen. Such coupling assemblies have previously included a clutch pack of alternating discs coupled to an outer housing and an inner member such that compression of the clutch pack provides rotational coupling between the housing and the inner member. The compression of the clutch pack has previously been performed with a ring of frustoconical shaped actuating levers. Such actuating levers should be accurately positioned with respect to each other and the housing in order to provide effective operation of the coupling.

### SUMMARY OF THE INVENTION

An object of the present invention is to provide an improved mechanically applied coupling assembly.

In carrying out the above object, the mechanically applied coupling assembly of the invention includes an annular housing having a central axis and also includes an inner member received within the housing. A coupling pack is received within the housing and has discs spaced along the central axis in first and second sets that alternate with each other and respectively have alternating connections to the annular housing and the inner member. A set of actuating levers of the coupling compresses the coupling pack to rotationally couple the annular housing and the inner member to each about the central axis. This set of actuating levers is spaced around the central axis and has outer ends supported by the housing. The actuating levers also have inner ends that are located toward the central axis from the outer ends. Each actuating lever has a pair of sides that converge toward each other from its outer end toward its inner end, and the sides of the actuating levers have interlocking formations that retain the adjacent actuating levers to each other and thereby maintain positioning of the actuating levers with respect to the housing.

The interlocking formations on the sides of each actuating lever include a projection on one side and an opening on the other side. The projection on the one side of each actuating lever has a generally semicircular shape of a constant radius, and the opening on the other side of each actuating lever has a flat center and curved portions on each side of the flat center. The curved portions of the opening of each actuating lever have a constant radius equal to the constant radius of its projection.

The housing of the coupling assembly has inwardly facing splines, and the outer ends of the actuating levers each have at least one projection for providing rotational coupling thereof about the central axis to the splines of the housing. The inner ends of the actuating levers have formations for connection to an actuator of the coupling assembly. More specifically, the outer ends of the actuating levers as disclosed each has a pair of projections for providing the rotational coupling thereof about the central axis to the splines of the housing, and the formations on the inner ends of the actuating levers each include a pair of projections for providing the connection to the actuator of the coupling assembly.

The actuating levers have flat shapes and the coupling assembly also includes an actuator ring located between the actuating levers and the coupling pack. This actuator ring has a first axial face of a flat shape that engages the coupling pack and also has a second axial face directed in the opposite axial direction as the first face. This second axial face of the actuator ring has an outer flat surface that engages the outer ends of the actuating levers prior to operation of the actuator of the coupling assembly. The second axial face of the actuator ring also has an inner frustoconical surface that extends axially toward the clutch pack in a radial direction toward the central axis. A retaining ring of the coupling assembly is secured to the housing on the opposite side of the outer ends of the actuating levers from the outer flat surface of the actuating ring to cooperate therewith in locating the actuating levers with respect to the housing.

The objects features and advantages of the present invention are readily apparent from the following detailed description of the preferred embodiment when taken in connection with the accompanying drawings.

### BRIEF DESCRIPTION OF THE DRAWINGS

FIG. 1 is an exploded perspective view of a mechanically applied coupling assembly constructed in accordance with the present invention.

FIG. 2 is a perspective view that further illustrates actuating levers for providing operation of a clutch pack of the coupling assembly.

FIG. 3 is a plan view of one of the actuating levers so as to further illustrate its construction.

FIG. 4 is a perspective view of the coupling assembly illustrated in section and partially disassembled to better show its construction.

### DETAILED DESCRIPTION OF THE PREFERRED EMBODIMENT

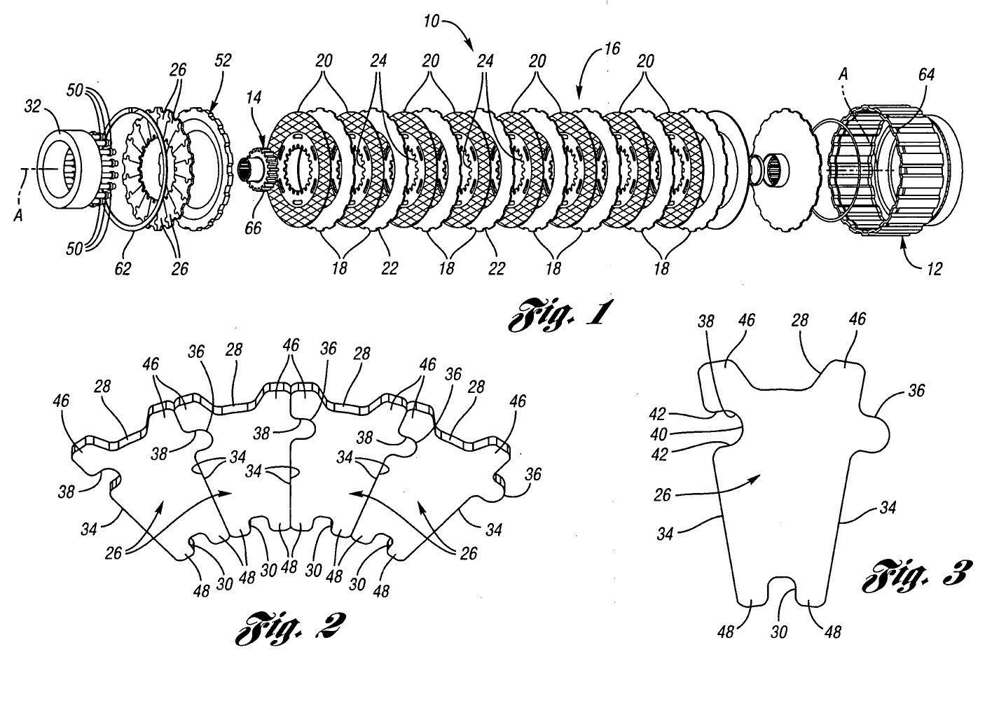

With reference to FIG. 1 of the drawings, a mechanically applied coupling assembly constructed in accordance with the invention is generally indicated by 10 and includes an annular housing 12 having a central axis A. An inner member 14 of the coupling assembly is received within the housing in its assembled condition. A coupling pack 16 of the coupling assembly 10 is also received within the annular housing 12 and includes annular discs 18 and 20 spaced along the central axis A in first and second sets that alternate with each other and have respective connections 22, 24 to the annular housing 12 and the inner member 14 as is hereinafter more fully described.

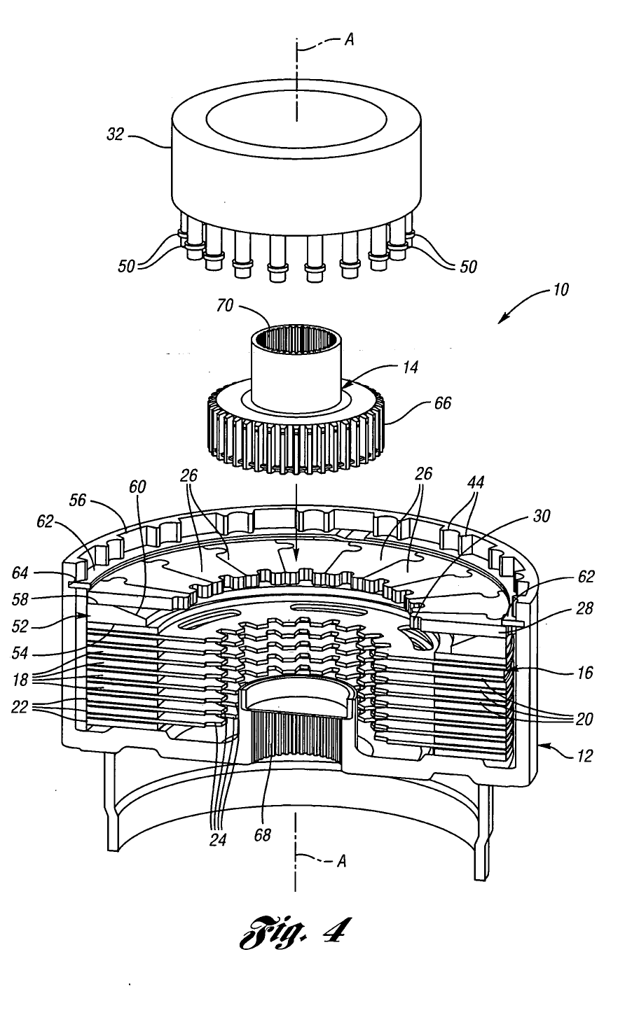

With continuing reference to FIG. 1 and additional reference to FIGS. 2 and 3, the coupling assembly 10 also includes a set of actuating levers 26 that are arranged in an annular ring about the central axis A and function to compress the clutch pack 16 in order to rotationally couple the annular housing 12 and the inner member 14 to each other about the central axis A. This set of actuating levers 26 has an annular shape spaced about the central axis A, and the actuating levers 26 have outer ends 28 that are supported by the housing 12 in the assembled condition. The actuating levers also have inner ends 30 that are located toward the central axis A from their outer ends 28. An actuator 32 shown in FIG. 1 and hereinafter more fully described operates on the inner ends 30 of the actuating levers to compress the clutch pack in order to provide rotational coupling of the outer housing 12 and the inner member 14. Each of the actuating levers 26 also has a pair of sides 34 that converge toward each other from its outer end 28 toward its inner end 30 as best illustrated in FIG. 3. The sides 34 of the actuating levers 26 have interlocking formations 36 and 38 that retain the adjacent actuating levers to each other and thereby maintain positioning of the actuating levers with respect to the housing.

As best shown in FIGS. 2 and 3, the interlocking formations on the sides of each actuating lever 26 include a projection 36 on one side and an opening 38 on the other side. Thus, the projection 36 of each actuating lever 26 is received within the opening 38 of the adjacent actuating lever at one of its sides and its opening 38 receives the projection 36 of the adjacent actuating lever at its other side. The projection 36 on each actuating lever 26 has a generally semicircular shape of a constant radius, while the opening 34 on the other side of each actuating lever has a flat center 40 and curved portions 42 on each side of the flat center. These curved portions 42 of the opening 38 of each actuating lever have a constant radius equal to the constant radius of its projection 36. This construction of the projection 36 and the opening 38 provides the interlocking of the actuating levers 26 while insuring that there is no interference in their mating relationship that provides this interlocking.

As shown in FIGS. 1 and 4, the annular housing 12 has inwardly facing splines 44 and the outer ends 28 of the actuating levers 26 each has a pair of projections 46 for providing rotational coupling thereof about the central axis A to the splines 44 of the housing. Furthermore, the inner ends 30 of the actuating levers 26 have a pair of formations 48 as shown in FIG. 3 for connection to the actuator 32 at actuating portions 50 thereof best illustrated in FIG. 4.

As illustrated in FIGS. 1-4, the actuating levers 26 have flat shapes and can thus be readily formed from flat metal stock. An actuator ring 52 of the coupling assembly 10 is located between these flat actuating levers 26 and the clutch pack 16 as shown in FIGS. 1 and 4. This actuator ring 52 has a first axial face 54 of a flat shape that engages the coupling pack 16 as shown in FIG. 4 and also has a second axial face 56 directed in the opposite axial direction along the central axis A as the first face. The second axial face 56 of the actuator ring 52 has an outer flat surface 58 that engages the outer ends 28 of the actuating levers 26 prior to operation of the actuator 32. The second axial face 56 of the actuator ring 52 also includes an inner frustoconical surface 60 that extends axially toward the coupling pack 16 in a radial inward direction toward the central axis A. A retaining ring 62 of the coupling assembly 10 is secured to the housing 12 on the opposite side of the outer ends 28 of the actuating levers 26 from the outer flat surface 58 of the actuator ring 52 to cooperate therewith in locating the actuating levers with respect to the housing. More specifically, the splines 44 of the housing have an annular slot 64 that receives the retaining ring 62, which has a split construction that allows its diameter to be compressed for insertion into this annular slot in the assembled condition. These housing splines 44 also received the connections 22 of the one set of discs 18 of the coupling pack while splines 66 of the inner member received the connections 24 of the other set of discs 20 of the coupling pack. Housing 12 and the inner member 14 also each have a set of internal splines 68 and 70, respectively, for providing rotational connection to associated members whose relative rotation is controlled by the coupling assembly.

With reference to FIG. 4, downward movement of the actuator 32 causes its actuating portions 50 to move the inner ends 30 of the actuating levers 26 downwardly. The retaining ring 62 prevents upward movement of the outer ends 28 of the actuating levers 26 such that the net effect is that the actuator levers pivot about the junction between the outer flat surface 58 and the inner frustoconical surface 60 of the actuator ring 52 and thereby provide downward movement of the actuator ring to compress the clutch pack 16. This compression of the clutch pack 16 prevents relative rotation between the first and second sets of alternating discs 18 and 20 so that the housing 12 is rotatively coupled to the inner member 14 to prevent rotation between these components. Subsequent upward movement of the actuator 32 allows the decompression of the clutch pack 16 as the actuating levers move back to their unactuated position of FIG. 4 to thereby allow the rotation between the housing 12 and the inner member 14. During this operation, the interlocking portions provided by the projection 36 and opening 38 of the actuating levers prevent movement thereof with respect to each other and thereby maintain the annular ring shape of the actuating levers that maintains its positioning within the housing in the assembled relationship.

While the preferred embodiment for carrying out the invention has been described in detail, those familiar with the art to which this invention relates will recognize alternative designs and embodiments for practicing the invention as defined by the following claims.

1. A mechanically applied coupling assembly comprising:
an annular housing having a central axis;
an inner member received within the housing;
a coupling pack received within the housing and having discs spaced along the central axis in first and second sets that alternate with each other and respectively have connections to the annular housing and the inner member; and
a set of actuating levers for compressing the coupling pack to rotationally couple the annular housing and the inner member to each other about the central axis, the set of actuating levers being spaced around the central axis and having outer ends supported by the housing, the actuating levers having inner ends that are located toward the central axis from their outer ends, each actuating lever having a pair of sides that converge toward each other from its outer end toward its inner end; and the sides of the actuating levers having interlocking formations that retain the adjacent actuating levers to each other and thereby maintain positioning of the actuating levers with respect to the housing.

2. A mechanically applied coupling assembly as in claim 1 wherein the interlocking formations on the sides of each actuating lever include a projection on one side and an opening in the other side.

3. A mechanically applied coupling assembly as in claim 2 wherein the projection on the one side of each actuating lever has a generally semicircular shape of a constant radius, the opening on the other side of each actuating lever having a flat center and curved portions on each side of the flat center, and the curved portions of the opening of each actuating lever having a constant radius equal to the constant radius of its projection.

4. A mechanically applied coupling assembly as in claim 1 wherein the housing has inwardly facing splines, the outer ends of the actuating levers each having at least one projection for providing rotational coupling thereof about the central axis to the splines of the housing, and the inner ends of the actuating levers having formations for connection to an actuator of the coupling assembly.

5. A mechanically applied coupling assembly as in claim 4 wherein the outer ends of the actuating levers each has a pair of projections for providing the rotational coupling thereof about the central axis to the splines of the housing, and the formations on the inner ends of the actuating levers each include a pair of projections for providing the connection to the actuator of the coupling assembly.

6. A mechanically applied coupling assembly as in claim 1 wherein the actuator levers have flat shapes and further including an actuator ring located between the actuating levers and the coupling pack, the actuator ring having a first axial face of a flat shape that engages the coupling pack and also having a second axial face directed in the opposite axial direction as the first face, the second axial face of the actuator ring having an outer flat surface that engages the outer ends of the actuating levers prior to operation of an actuator of the coupling assembly, the second axial face of the actuator ring having an inner frustoconical surface that extends axially toward the coupling pack in a radial inward direction toward the central axis, and the coupling assembly including a retaining ring secured to the housing on the opposite side of the outer ends of the actuating levers from the outer flat surface of the actuating ring to cooperate therewith in locating the actuating levers with respect to the housing.

7. A mechanically applied coupling assembly as in claim 1 wherein the interlocking formations on the sides of each actuating lever include a projection on one side and an opening in the other side, the housing having inwardly facing splines, the outer ends of the actuating levers each having at least one projection for providing rotational coupling thereof about the central axis to the splines of the housing, and the inner ends of the actuating levers having formations for connection to an actuator of the coupling assembly.

8. A mechanically applied coupling assembly as in claim 7 wherein the actuator levers have flat shapes and further including an actuator ring located between the actuating levers and the coupling pack, the actuator ring having a first axial face of a flat shape that engages the coupling pack and also having a second axial face directed in the opposite axial direction as the first face, the second axial face of the actuator ring having an outer flat surface that engages the outer ends of the actuating levers prior to operation of an actuator of the coupling assembly, the second axial face of the actuator ring having an inner frustoconical surface that extends axially toward the coupling pack in a radial inward direction toward the central axis, and the coupling assembly including a retaining ring secured to the housing on the opposite side of the outer ends of the actuating levers from the outer flat surface of the actuating ring to cooperate therewith in locating the actuating levers with respect to the housing.

9. A mechanically applied coupling assembly comprising:
an annular housing having a central axis and having internal splines spaced about the central axis;
an inner member received within the housing and having external splines;
a coupling pack received within the housing and having discs spaced along the central axis in first and second sets that alternate with each other and respectively have outer and inner splines meshed with the internal splines of the annular housing and the external splines of the inner member;
a set of actuating levers for compressing the coupling pack to rotationally couple the annular housing and the inner member to each other about the central axis, the set of actuating levers being spaced around the central axis and having outer ends meshed with the internal splines of the housing, the actuating levers having inner ends that are located toward the central axis from their outer ends, each actuating lever having a pair of sides that converge toward each other from its outer end toward its inner end, and the pair of sides of each actuating lever respectively having a projection and an opening that mate with the projection and opening of the adjacent actuating levers to retain the actuating levers to each other and thereby maintain positioning of the actuating levers with respect to the housing; and
an actuator that moves the inner ends of the actuating levers toward the coupling pack to compress the coupling pack and rotationally couple the housing and the inner member.

10. A mechanically applied coupling assembly comprising:
an annular housing having a central axis and having internal splines spaced about the central axis;
an inner member received within the housing and having external splines;
a coupling pack received within the housing and having discs spaced along the central axis in first and second sets that alternate with each other and respectively have outer and inner splines meshed with the internal splines of the annular housing and the external splines of the inner member;
a set of actuating levers for compressing the coupling pack to rotationally couple the annular housing and the inner member to each other about the central axis, the set of actuating levers having flat shapes and being spaced around the central axis, the actuating levers having outer ends meshed with the internal splines of the housing, and having inner ends that are located toward the central axis from their outer ends, each actuating lever having a pair of sides that converge toward each other from its outer end toward its inner end, and the pair of sides of each actuating lever respectively having a projection and an opening that mate with the projection and opening of the adjacent actuating levers to retain the actuating levers to each other and thereby maintain positioning of the actuating levers with respect to the housing;
an actuator ring located between the actuating levers and the coupling pack, the actuator ring having a first axial face of a flat shape that engages the coupling pack and also having a second axial face directed in the opposite axial direction as the first face, the second axial face of the actuator ring having an outer flat surface that initially engages the outer ends of the actuating levers, the second axial face of the actuator ring having an inner frustoconical surface that extends axially toward the coupling pack in a radially inward direction toward the central axis;
a retaining ring secured to the housing on the opposite side of the outer ends of the actuating levers from the outer flat surface of the actuating ring to cooperate therewith in locating the actuating levers with respect to the housing; and
an actuator that moves the inner ends of the actuating levers toward the coupling pack to compress the coupling pack and rotationally couple the housing and the inner member.
